(19) United States
(12) Patent Application Publication
(10) Pub. No.: US 2009/0012760 A1
(43) Pub. Date: Jan. 8, 2009

(54) METHOD AND SYSTEM FOR ACTIVITY MONITORING AND FORECASTING

(76) Inventor: ALAN J. SCHUNEMANN, Las Vegas, NV (US)

Correspondence Address: DLA PIPER LLP US, P. O. BOX 2758, RESTON, VA, 20195, US

(21) Appl. No.: 12/112,314

(22) Filed: Apr. 30, 2008

Related U.S. Application Data
(60) Provisional application No. 60/914,869, filed on Apr. 30, 2007.

(51) Int. Cl. G06G 7/48

(52) U.S. Cl. 703/6

(57) ABSTRACT

A system and method for creating models related to an organization, comprising: collecting data from electronic activity; conducting an electronic data analysis by analyzing the data; conducting an organization data analysis analyzing organization data from the organization; and creating a model of the organization based on the electronic data analysis and/or the organization data analysis.

This application claims priority to U.S. provisional application 60/914,869, filed Apr. 30, 2007, and entitled: “System and Method for Activity Monitoring and Performance Forecasting”, which is herein incorporated by reference.

### BRIEF DESCRIPTION OF THE FIGURES

FIG. 1 illustrates a system for monitoring and forecasting performance of an organization, according to one embodiment.

FIG. 2 illustrates a method for monitoring and forecasting performance of an organization, according to one embodiment.

FIGS. 3-6 illustrate various examples of reports that can be generated, according to several embodiments.

### DESCRIPTION OF EMBODIMENTS OF THE INVENTION

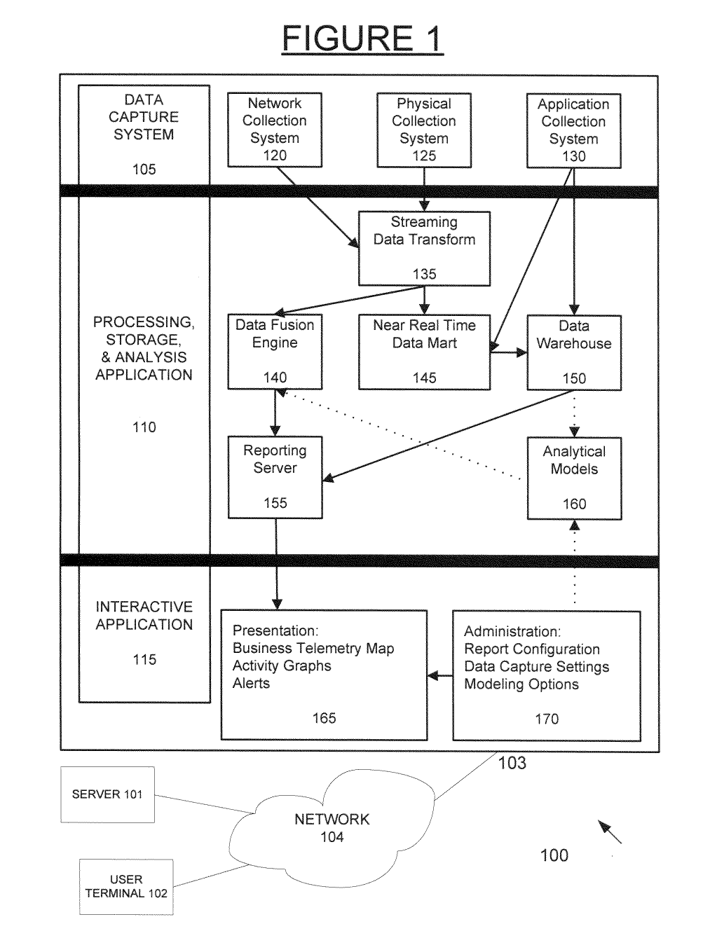

FIG. 1 illustrates a system for monitoring and forecasting performance of an organization, according to one embodiment. Those of ordinary skill in the art will see that any organization (e.g., business, non-profit, government, etc.) can be monitored and forecasted. When monitoring an organization, data can be collected and analyzed in real time (and/or near real time), and managers can respond to situations as they are happening. A real time system can be a system that responds to events or signals within a predictable time after their occurrence (e.g., within a maximum time). A near real time system can be a system that responds to events or signal close to a predictable time after their occurrence.

FIG. 1 illustrates system 100 with a server 101, a user terminal 102, and an application 103, all connected by a network 104. The application 103 can include a data capture system 105; a processing, storage, and analysis application 110; and an interactive application 115. The data capture system 105 can capture data at various points of collection. Organizations rely on email and network based applications for communications and information systems to run their entity. The amount of network data flowing into, out of, and within an organization can be significant and is often observable. Network activity can be interpreted as indicators of organization activity, and the digital nature of some information can be leveraged to open the door to a whole new world of real time business information. Operational events, processes, and data from across an organization can be utilized, which can include network communication, databases, telephone systems, quality monitoring systems, scheduling systems, and other sources. Data capture can include source data collection for various activity indicators and can include: a network collection system 120, a physical collection system 125, and an application collection system 130.

Network collection system 120 can track network activity such as email activity, instant message activity, voice-over IP activity, Intranet application activity, Internet activity, Web discussion forums, Web browsing, use of Internet systems/resources, and/or use of Intranet systems/resources.

Email represents an activity indicator for most organizations, because it is an important and effective means of communication, and can yield reliable data, sometimes with modest collection expense. Employees can be logged in from almost anywhere, and their email activity can still be properly attributed. Key data can be obtained from email header fields (and the body of the email does not necessarily need to be captured in some situations), which can improve collection efficiency and alleviate privacy issues. Header data includes sender(s), receiver(s), date/time, and subject. The sender(s) and receiver(s) can be assigned attributes such as internal, external, department, office, client, partner, government, unknown, etc., enabling aggregated activity to be reliably broken down. Further data that can be obtained without detailed examination of the message body can include: size of message, number, types, size of attachments, and position in email thread (e.g., reply).

Web browsing can include employee Web activity and all activity on an organization's Web site. Examining employee Web browsing behavior can help understand how Web activity for groups of employees varies and can indicate when something unusual or interesting is happening. Web activity data can be captured in the form of URLs visited and files downloaded. These can be assigned attributes such as: internal, client or partner-related, industry or competitor information, travel, news, leisure, job search, or unknown. With additional analysis effort, viewing times can also be estimated.

Instant messaging (IM) can be a popular and handy form of informal communication. Usage can vary widely. Similar to email, information such as sender(s), receiver(s), and date/time can be obtained from headers without examining the message body. Likewise, sender/receiver attributes like internal versus external can be assigned to allow meaningful aggregations of activity.

Use of internal application resources (e.g., Intranet) can be an important part of how employees spend their time. Data in the following Intranet application can be tracked: support/helpdesk; time and labor (e.g., tracked by a human resource department), expenses-accounting; phonebook, and/or calendar. In addition, non-application based internal systems can be monitored, such as access data for centralized file servers acting as repositories for documents and information resources.

The Internet can also be a legitimate part of how employees spend time. Visitation of specific “approved” Web sites, as well as visitation of other Web sites can be tracked.

Physical collection system 125 can collect data from one or more Private Branch Exchanges (PBXs), building access systems, office equipment (e.g., computers), security systems, workstation agents, server logs, and/or results of paper or electronic surveys. Some of this data may require augmentation to make the data available for processing in the system. Some sources may be incomplete, and require augmentation or translation by referencing other resources. For example, security access logs may identify employees by an internal ID. To determine the actual person referenced in a log entry, the internal ID would need to be referenced in another resource listing people, and their assigned internal IDs. As another example, PBX phone logs may list phone activity by phone numbers without listing the names of the people to which the phones are assigned. To determine the participants of a given PBX phone log entry, the phone numbers would be referenced in another resource such as a staff directory that lists people, and their assigned phone numbers.

Network phone activity (in the organization) can be monitored. In addition, call center activity can be monitored. Phone related statistics that can be tracked include: call duration, hold time, frequency for call center; time to return calls from voicemail messages; calls to primary contact numbers and executive administrative assistants; and internal versus external calls.

Tracking physical access to facilities by employees (e.g., card swipe) can provide data on start time, leave time, and building access patterns. Facilities data could also include temperature and electrical usage statistics.

Application collection system 130 can collect data from Enterprise Resource Planning (ERP) software (e.g., software for managing orders, inventory etc.), finance software. Customer Relationship Management (CRM) software (e.g., marketing, sales, etc.), or Web server logs (e.g., information on visitors to an entity's Web site).

Local area and wide area network traffic can be viewed as traveling between an origin and a destination, either of which can be internal or external to the organization, or to a business component of interest such as a department or office. Information exchange is directional, and can be defined in four different path types relative to any given sender/receiver of data: internal, inbound, outbound, external. For each of these business activity pathways, certain activity indicators will be particularly useful. The pathway definitions provide a conceptual framework for mapping data flowing on the network and electronic infrastructure to meaningful business activity.

Internal activity can be defined as any communication that starts and ends within the organization being considered. For example, all email, Instant Messaging (IM), and calls between employees are internal to the organization as a whole, and so is all employee use of Intranet applications. For a specific office, communication between employees of that office and their Intranet use would be considered internal to the office. Facility access and Intranet/internal application activity can be thought of as starting and ending at the same place.

Inbound activity can be defined as any communication that goes to the organization being considered, but originated outside of it. For the organization as a whole, this includes all world-to-business emails, IM, and phone calls. It is also reasonable to include employee Web browsing activity, since this primarily consists of substantial amounts of data sent from an outside Web server to the employee's browser. For a given office or department, inbound activity can be further broken down into a) origination elsewhere within the organization, and b) non-organization origination.

Outbound activity can be defined as any communication that begins at the organization being considered and ends outside of it. For the organization as a whole, this includes all business-to-world emails, IM, and phone calls. It can also include hits to the organization's Web site, since this primarily consists of substantial amounts of data sent from an organization's Web server to an external party's browser. For a given office or department, outbound activity can be further broken down into a) destination elsewhere within the organization, and b) destination outside the organization. External activity can be defined as data that is completely external to the organization but nevertheless can be monitored and leveraged for real time business information. This could include weather conditions, economic/market data, and news alerts.

It should be noted that certain combinations of activity indicators can give rise to interesting high-level business performance indicators. For example, by collating inbound and outbound email, phone, Web browsing, and IM activity where the origin or destination is unknown or known to be non-work related, it should be possible to track estimated employee non-working time within a given business component.

Processing, storage & analysis application 110 can filter, transform, analyze and store data, and can also track and report on various metrics (e.g., business metrics). Activity monitoring and performance modeling and forecasting can be provided. A streaming data transform application 135 can be included, which can capture data from streams in real time (and/or near real time). The streaming data transform application 135 can capture information and transform the streams into a suitable form for loading it into a data fusion engine 140 or a near real time data mart 145. An example method of analyzing email network activity is by analyzing SMTP headers. By analyzing the SMTP headers in email network activity, information regarding the nature of the email can be obtained. Information that can be obtained from an email includes: the time the email was sent, the subject of the email, the email address of the sender, the email address of the recipient, the name of the sender, and/or the name of the recipient. Other information in the header could be used to determine from which resources the emails were delivered, and provide insight to the location of the email sender and recipient. For example, information such as the sender's email client and system type, the SMTP server addresses, and/or time zone stamps can be obtained. Additionally, the body of the email could be stored for later analysis. Example analyses of the email body can include keyword scanning, context analysis, psychological profiling, and/or scanning for presence of intellectual property. As another example, The activity history of a PBX phone system may be obtained by various methods (e.g., an installed agent that collects information, by reading activity log files, and/or by querying information from the PBX phone system via a service). Information obtained from a PBX phone system can include: phone numbers of participants in the phone call or conference call, initiator of a call, time the call was made, time the call was ended. A recording or content of the call may also be available for further analysis.

The data fission engine 140 can calculate critical information from various activity indicators (e.g., using network collection system 120, physical collection system 125, and application collection system 130). Processing can combine real time data with near real time aggregate data and apply appropriate analysis to determine the information output to send to reporting server 155 for presentation. When analytical models are used to calculate predictions (e.g., business performance predictions), the data fusion engine 140 can apply those analytical models to the incoming data.

The near real time data mart 145 can be a specialized data warehouse for calculating and storing temporary aggregates from streaming data for a certain time period (e.g., minutes, hours, days, etc.). Some aggregates can eventually be moved to the data warehouse 150 while other aggregates can be discarded when their usefulness expires. Until they are moved or expire, the aggregates are available for the data fusion engine 140 to complement the real time information, for normalization and/or comparison reporting purposes. For example, comparing the current value of a given indicator to its running average value over a 24-hour period can provide important business information. This requires tracking the 24-hour running average and making it readily accessible. In some situations, all of the tracked information does not need to become part of a permanent data store. Thus, the near real time data mart 145 can be a buffer storage for temporarily useful aggregate information. In contrast, the data warehouse 150 can store data in a more permanent function. In analytical models 160, data from the data warehouse 150 can be analyzed, for example, for correlation models between activity collected by network collection system 120, and data collected by application collection system 130. The data fusion engine 140 applies these models to data from the near real time data mart 145, and data from the streaming data transform 140 to produce expected values according to the model. The data fusion engine 140 also provides to the reporting server 155, the data from the near real time data mart 145, and data from the streaming data transform 140. The reporting server 155 generates reports that display the data in the data warehouse 150, and the results from the data fusion engine 140.

The interactive application 115 can be a user interface that provides organization activity monitoring, employee activity monitoring, reporting and/or forecasting. The type and format of information delivery can be tailored to a variety of different end-users. Administration information 170 can be used to configure reports, set data capture settings, and give modeling options. Presentations 165 can illustrate information (e.g., business telemetry maps, activity graphs, alerts).

Examples of use of the interactive application 115 include the following: an executive can get a pulse of the business at anytime with Internet access; a manager or director can have early warning radar for business critical situations in their department; finance personnel can monitor real time global financial positions, foreign currency and economic information in an integrated fashion; marketing personnel can get instant feedback on the performance of marketing initiatives and can manage campaigns more effectively; warehouses can function with less stock, with managers outside the warehouse having real time access to inventory ordering, and sales data; a trucking company manager could be paged when the fleet's carrying capacity drops below a predetermined threshold; call center staff who need a real time view of customer and supply chain metrics (beyond limited context provided by the automatic call distributor) can be given real time information; sales executives who want a real time view of sales orders, providing better visibility into the order pipeline to complement historical offer data and as a cross-check on sales forecasts, can be provided with this information; corporate treasury and pension departments, which want to monitor real time global financial positions, foreign currency and economic information in an integrated way, can obtain this information; and factory-floor managers who need material requirements planning, inventory and sales metrics, can be provided this information on a real time basis.

Once the activity is captured, it is fused and data mining techniques are applied to discover consistent and useful relationships between the activity and the organization's performance. The interactive application 115 can then display this activity and its relationship to the organization's performance as it occurs in near real time. An organization's performance, and other metrics, can be forecast using historic electronic infrastructure activity patterns.

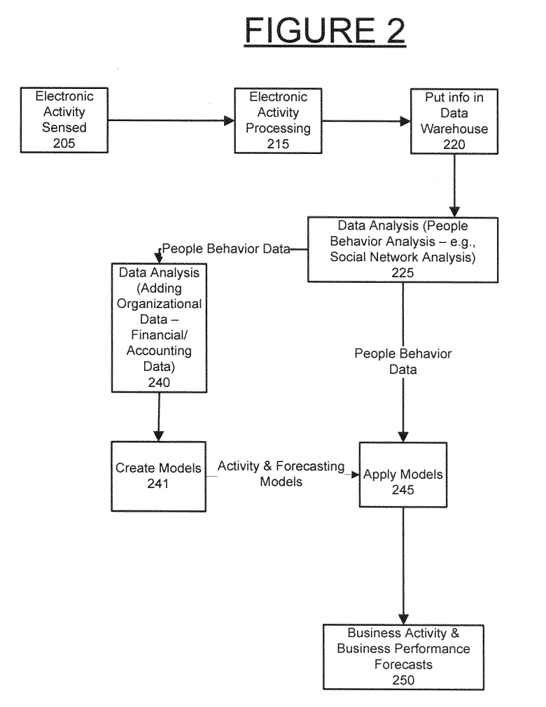

FIG. 2 illustrates a method for monitoring and forecasting performance of an organization, according to one embodiment. In 205, electronic activity is collected. Electronic activity could be data illustrating activity in a network (e.g., computer network, phone network, PBX), activity in a physical place (e.g., office equipment, security system, building access system), and/or activity in an application (e.g., a business application). The electronic activity can be sensed or collected utilizing hardware (e.g., a sensor which can extract useful information from raw data), software, or any combination thereof. For example, message interceptions can be collected. In addition, person network usage can be collected. A message may have multiple attributes to be captured such as, but not limited to, “to” person(s), “from” person(s), IP address, port, email address, date, time, messaging protocol, duration, size, attachments, and content analysis. The messaging protocols can include email, instant message, chat, and other protocols that support messaging between two or more parties. Content analysis could include information in protocol headers, keyword matching on the content, regular expression matching on the content, and other forms of syntactic or semantic analysis of the content. Person network usage can be a recording of the usage of the electronic activity resources by a certain person(s). This could be Web surf time, chat time, and/or phone time. It could also include counts of the utilization of the different messaging protocols such as phone, email, instant messaging, chat, and other protocols that support messaging. It could also measure bandwidth utilization. Persons can be identified from the raw data. Those of ordinary skill in the art will be aware of various methods for collecting data related to an organization.

In 215, the collected data from the electronic activity is processed using the processing, storage, and analysis application 110 to derive electronic activity data. For example, from an electronic email (raw data), electronic activity data such as mailer and recipient, the size, content, and or the attachment may be derived. In 220, the electronic activity data is then stored in data warehouse 150. Note that data can also be retrieved from the data warehouse 150.

In 225, the electronic activity data is analyzed for people behavior issues using the processing, storage, and analysis application 110. The people behavior analysis can include a time series analysis (patterns and trends related to time), correlation, pattern recognition, regression, a spectral analysis (e.g., frequency, seasonal), and/or a social network analysis.

For example, in one embodiment, data from the message intercepts can be constructed into a graph where the nodes represent the persons and the links represent the messages. Both the nodes and links can have attributes. Node attributes can be the name of the person, data related to the nature of the person, and the date and time the person was first placed in the database. Links can have attributes such as date, time, messaging protocol, duration, size, attachments, and content analysis. Person network usage information can be stored in a manner where it is associated with a person assigned to a node, either as an attribute or in separate tables.

The people behavior analysis can analyze data associated with people behavior observed from the electronic activity. The people behavior analysis can also calculate the cumulative totals of a particular measurement or observation of a person's communications activities over a specific time period. For example, how much time a user is spending surfing Web sites, emailing externally, etc., can be determined. In addition, certain Web sites could be designated as work/productive Web sites, so that surfing those Web sites would be considered working, whereas surfing non-work/non-productive Web sites could be considered non-productive/non-working time. Thus, the people behavior analysis can include calculating cumulative chat time, surf tune, phone time. It can characterize the type of usage such as business, personal, and prohibited activities. The analysis can also include cumulative counts of the number of messages by phone, e-mail, instant message, chat, and other protocols that support messaging between two parties. The analysis can also include the cumulative amount of data transferred or bandwidth utilization. Queries to a people behavior analysis in the processing, storage and analysis application 110 can be windowed over a designated time frame. Queries from a people behavior analysis in the processing, storage and analysis application 110 to the data warehouse 150 can be windowed over a designated time frame.

The social network analysis (SNA) can characterize the social interactions between people in an organization based on data capture. For example, a person's social network can include social networks within an organization, and social networks with other entities. A social network calculation can be performed on the graph and other data in the data warehouse 150 and/or near real time data mart 145. Social network calculation can be calculated over a window of a specific time frame. Social network calculation can be calculated in real time, as each new message from the sensor is received and added to the data warehouse.

Examples of the calculations that can be derived from the data stored in the data warehouse 150 and/or the near real time data mart 145 are: betweenness, centrality closeness, centrality degree, flow betweenness, centrality eigenvector, centralization, clustering coefficient, cohesion, contagion, density, integration, path length, radiality, reach, structural equivalence, and structural hole. These calculations are described in more detail below:

Betweenness can be the degree an individual lies between other individuals in the network; the extent to which a node is directly connected only to those other nodes that are not directly connected to each other; and/or an intermediary; liaison; and/or bridge. Betweenness can be the number of people who a person is connected to indirectly through their direct links.

Centrality closeness can be the degree an individual is near all other individuals in a network (directly or indirectly). It can reflect the ability to access information through the “grapevine” of network members. Closeness can be the inverse of the sum of the shortest distances between each individual and every other person in the network.

Centrality degree can be the count of the number of ties to other actors in the network.

Flow betweenness can be the degree that a node contributes to a sum of maximum flow between all pairs of nodes.

A centrality eigenvector can be a measure of the importance of a node in a network. Relative scores can be assigned to all nodes in the network based on the principle that connections to nodes having a high score contribute more to the score of the node in question.

Centralization can be the difference between the n of links for each node divided by the maximum possible sum of differences. A centralized network can have much of its links dispersed around one or a few nodes, while a decentralized network can be one in which there is little variation between the n of links each node possesses

A clustering coefficient can be a measure of the likelihood that two associates of a node are associates themselves. A higher clustering coefficient can indicate a greater ‘cliquishness’.

Cohesion can refers to the degree to which actors are connected directly to each other by cohesive bonds. Groups can be identified as ‘cliques’ if every actor is directly tied to every other actor, ‘social circles’ if there is less stringency of direct contact, which is imprecise, or as structurally cohesive blocks if precision is wanted.

Density related to individuals can be the degree a respondent's ties know one another/proportion of ties among an individual's nominees. Network or global-level density can be the proportion of ties in a network relative to the total number possible (sparse versus dense networks).

Path Length can be the distances between pairs of nodes in the network. Average path-length can be the average of these distances between all pairs of nodes.

Radiality can be the degree an individual's network reaches out into the network and provides novel information and influence

Reach can be the degree any member of a network can reach other members of the network.

Structural equivalence can refer to the extent to which actors have a common set of linkages to other actors in the system. Note that the actors don't need to have any ties to each other to be structurally equivalent.

A structural hole can be a static hole that cart be strategically filled by connecting one or more links to link together other points. For example, if you link to two people who are not linked, you can control their communication.

Contagion can be the rate and pattern of the spread of an idea, topic, condition, or behavior throughout a community.

Integration can be the degree to which subgroups of individuals in a community are connected to other subgroups of individuals in the community.

Referring back to FIG. 2, in 240, the people behavior analysis information is combined with organizational data (e.g., financial information such as revenue, costs, assets, liabilities, return on investment, margin; and/or other business information such as customer relationship information, enterprise resource information, and Web server logs) using the processing, storage, and analysis application 110. Note that the business data can be provided for a specific time period.

In 241, models can be developed illustrating how the people behavior analysis is related to the business activity and performance using analytical models application 160. For example, the people behavior data and business data over a specified time period can be combined, and models can be built to determine business activity and predict a business performance metric. Data mining or pattern discovery methods for building the models can be used, including, but not limited to neural networks, support vector machines, linear and nonlinear multiple regression, spectral analysis, time series analysis, and/or any other form of model building and discovery.

Once the models are created, in 245 the electronic activity is continually monitored with the data capture system 105 and applied in business activity and predictive models which calculate real time business activity and predict business activity and the performance of business metrics based on the electronic activity using the processing, storage and analysis application 110. In 250, business performance metrics can be predicted based on the predictive models and/or business activity can be determined in real time (and/or near real time) based on the business activity models and using the interactive application 115.

In one example embodiment of FIG. 2, activity of people communicating via Internet chat can be sensed in 205. The raw network data of a chat message collected can then be processed in 215 to extract the chat handles of the participants, the content of the message, and the chat handles can be resolved to members of the organization. The extracted data can be stored in the data warehouse in 220. Over time, more chat messages from the same participants and other participants can be similarly collected, processed and stored into the data warehouse. In 225, the stored Internet chat data can be analyzed using a social network analysis to determine the degree, closeness centrality, and betweenness centrality measures for each of the various participants that communicated during a certain window of time (e.g., a one day time window). This analysis can be repeated periodically (e.g., every hour for the trailing 24-hour window), resulting in a time series (e.g., hourly) of social network analysis measures for each participant. The social network analysis measure time series can be compared in 240 to, for example, accounting data collected by application collection system 130. In 241, a predictive model can be created that relates an increase of the betweenness measure of an individual participant in the social network analysis time series data to a subsequent decrease in the hourly order fulfillment numbers derived from the accounting data. The predictive model can be saved, and applied to the ongoing stream of social network analysis time series data processed in 225. By applying the model in 245 to the social network analysis data, when an increase in the betweenness of the individual is shown, an decrease in order fulfillment can be predicted in 250.

In another example embodiment of FIG. 2, activity of a person surfing the Internet can be sensed in 205. The raw network data of the Internet activity can then be processed in 215 to extract the IP address of the person, the URL the person visited, the amount of data received, and the IP address is resolved to a member of the organization. The extracted data can be stored in the data warehouse in 220. Over time, more Internet surfing activity by the same participants and other participants can be similarly collected, processed and stored into the data warehouse. In 225, the stored Internet surfing data can be analyzed to determine collective time spent surfing the Internet per each division. For example, this analysis can be done hourly resulting in an hourly time series of time spent surfing for each division. The hourly time series of time spent surfing for each division can be compared in 240 to PBX phone volume data collected by physical collection system 125, transformed by streaming data transform 135. In 241, a predictive model can be created that relates an increased afternoon call volume to the support line to a subsequent increase of time spent surfing a technical reference information Web site by members of the customer support division. The predictive model can be saved, and applied to the ongoing stream Internet surfing time series data processed in 225. If over time, this model continues to correctly predict the increased Internet surfing habits, management of the organization may decide to make an organization change or corrective action, (e.g., by sliding the more technically knowledgeable members of the customer support division to cover the afternoon shift).

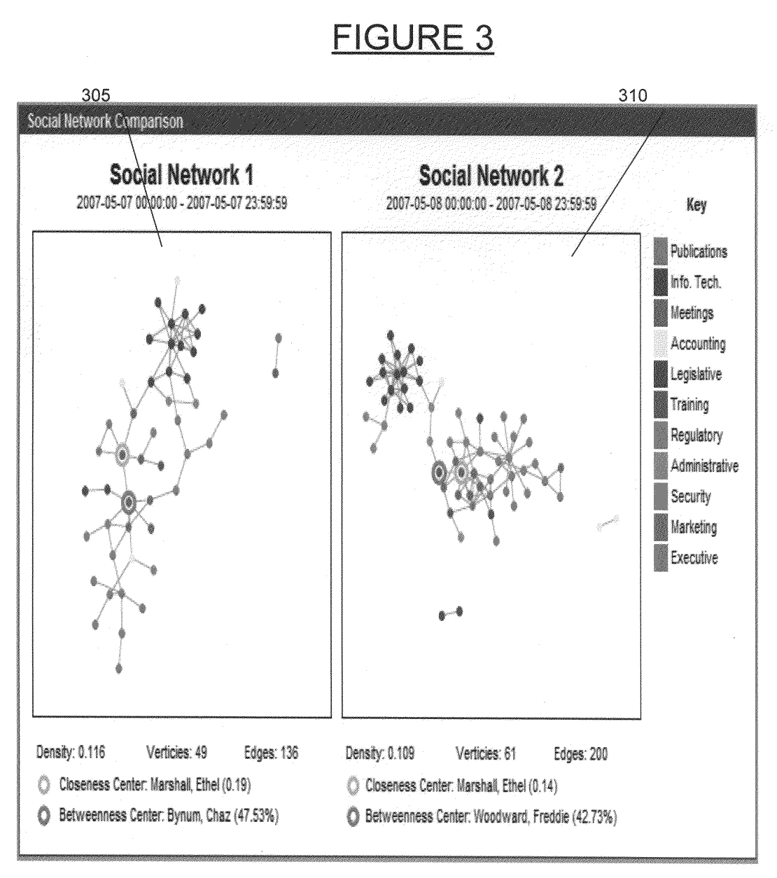

FIGS. 3-6 illustrate reports that can be generated from interactive application 115. As illustrated in FIG. 3, the interactive application 115 can help provide a real time social network analysis for an organization. The social network analysis can provide information, including, but not limited to, a visual representation of communication patterns of an organization. The example in FIG. 3 includes two information flow maps. Flow map 305 illustrates a flow map between, for example, various divisions in an organization over a time period (e.g., one day). Flow map 310 can show, for example, the flow map between the divisions over another time period (e.g., the following day). In this example, the changes in the information flow between divisions can be observed.

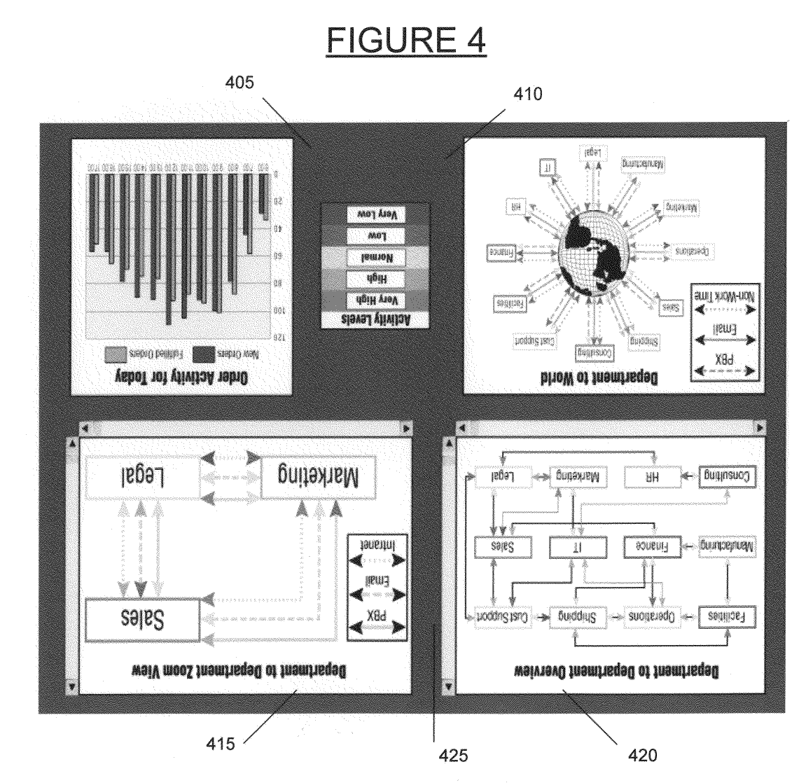

In one embodiment, the interactive application 115 can help provide a top down view of the activity between specified groups within an organization, and between those groups and/or the organization and the world. The interactive application 115 can partition activity into internal, inbound, and outbound activity. FIG. 4 illustrates an example of how the interactive application 115 can help overlay discoveries in an organization's social network model to its performance (e.g., leader activity levels). Referring to FIG. 4, nodes (e.g., facilities, operations) can represent groups, such as departments, and the connectors can indicate activity between these groups. Color, size, and type of nodes and/or connectors can be used to indicate different amounts or types of activities. Department to Department Overview 405 illustrates real time activity within an enterprise. As 410 illustrates, the different connectors used (e.g., in 405) can represent different types of communication (e.g., PBX, email, Internet). Department to World 415 illustrates activity between the organization and the outside world. Order Activity for Today 420 illustrates a report that indicates new orders and fulfilled orders tracked throughout the day. Order Activity for Today 420 may be based on order fulfillment information collected by, for example, the application collection system 130, stored in the near real time data mart 145, and passed through to the reporting server 155 to be processed as an hourly report. Activity Levels 425 in FIG. 4 is a key to the color coded activity levels used elsewhere on the report. Very High represents the highest level of activity and Very Low represents the lowest level of activity.

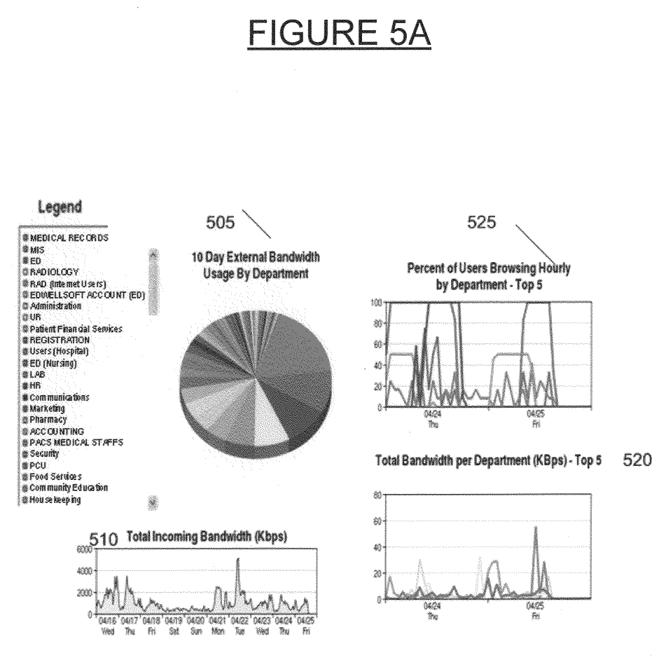

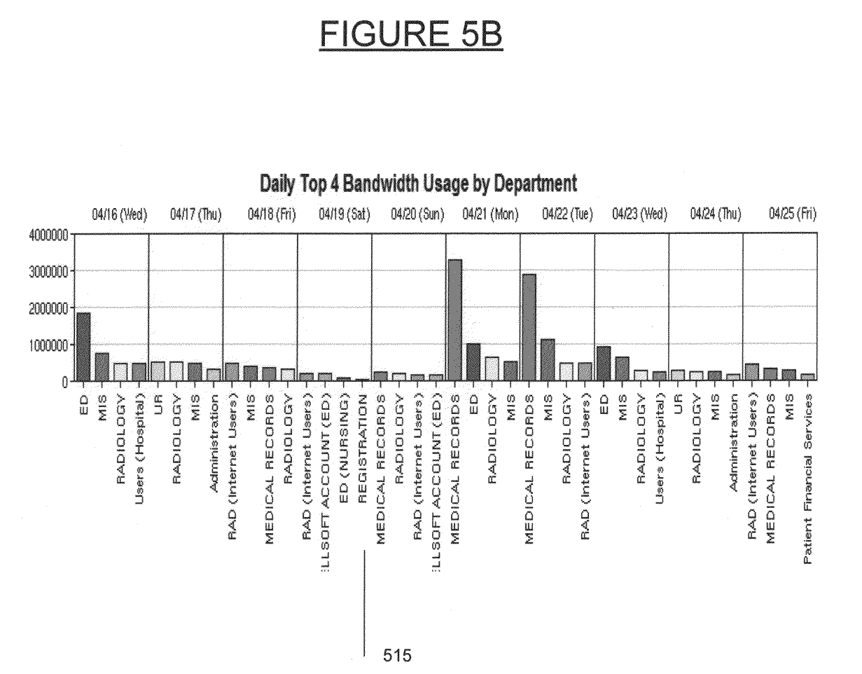

As another example of a report, employee non-working time, such as Web surfing and chatting, can be tracked, as shown in FIG. 5. The example in FIG. 5 is a dashboard report with various charts displaying network bandwidth usage and behavior per division including: a pie chart 505 showing total bandwidth used per department over a 10 day period, a line chart 510 showing the Internet bandwidth rates over time by all divisions over a 10 day period, a series of bar charts 515 showing the top bandwidth divisions per day over a 10 day period, a line chart 520 showing the bandwidth rates over a 2 day period for each of the top 5 divisions, and a line chart 525 showing the percent of users browsing (e.g., Web surfing) hourly over a 2 day period for each of the top 5 divisions.

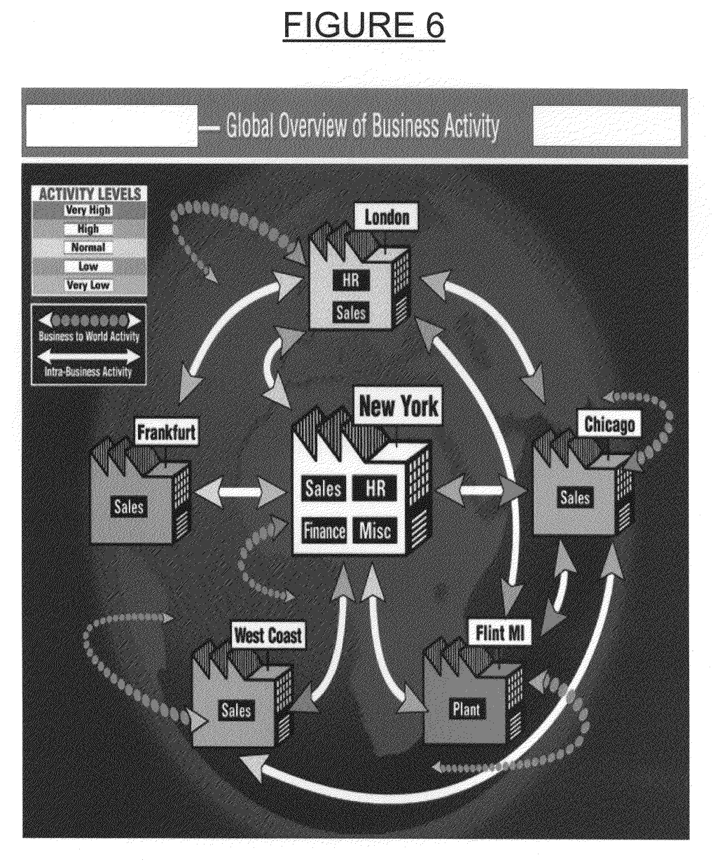

As an additional example, the activity of a business with several offices can be viewed in real time (and/or near real time) in terms of the activity of each office, and inter-office activity. FIG. 6 illustrates an example summary report that consolidates data from data capture sources, according to one embodiment. For example, in FIG. 6, activity of the plant in Flint is unusually high, while information exchange from the plant to the outside world is unusually low. This information flow map is essentially a social network, and therefore a social network analysis could be applied to this data which could, as an example, quantify the degree to which Flint is central to between the global interactions (e.g., see explanations of betweenness and centrality described above). As another example, a social network analysis could determine which of the plants are, on average, closest to all other plants (e.g., see explanations of closeness and centrality described above).

In one embodiment, the user can drill down into the data in the connectors and the business components in the reports (e.g., see FIG. 4) by clicking on a particular object. Clicking on the connectors can present a menu of different time series graphs available for the selected data. Summary statistics can be presented for a group by moving a mouse over the object. Special data which represents the organization as a whole can be clicked, and can then show a real time “dashboard” for the entire business. In some embodiments, the user can select from a variety of reports showing charts of key business data over time.

In additional embodiment, an alert can be set for the various activity indicators, or for combinations of these indicators. The alerts can refer to meta-data that represents various aggregated data stored in the near real time data mart 145 and/or data warehouse 150. For example, taken in context with longer-term data, the intra-day data may be actionable as it breaks a specific threshold. Alerts can be delivered to the screen and/or to the pager or email of the recipient.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above described exemplary embodiments.

In addition, it should be understood that any figures, screen shots, tables, examples, etc. which highlight the functionality and advantages of the present invention, are presented for example purposes only. The architecture of the present invention is sufficiently flexible and configurable, such that it may be utilized in ways other than that shown. For example, the components listed in any system diagram and/or flowchart (e.g., FIGS. 1 and 2) may be re-ordered or only optionally used in some embodiments.

Furthermore, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method for creating at least one model related to at least one organization, the method comprising:
collecting data from electronic activity;
conducting an electronic data analysis by analyzing the data;
conducting at least one organization data analysis analyzing organization data from the at least one organization;
creating at least one model of the at least one organization based on the at least one electronic data analysis and/or the at least one organization data analysis.

2. The method of claim 1, wherein the at least one electronic data analysis includes a people behavior analysis.

3. The method of claim 1, wherein the at least one model is utilized to create at least one organization activity model.

4. The method of claim 3, wherein the at least one organization activity model is utilized to quantify the at least one organization's activity.

5. The method of claim 1, wherein the at least one model is utilized to create at least one predictive model.

6. The method of claim 5, wherein the at least one predictive model is utilized to forecast performance of the at least one organization.

7. The method of claim 2, wherein the at least one people behavior analysis comprises at least one social network analysis.

8. A system for creating at least one model related to at least one organization, the system comprising:
at least one server coupled to at least one network;
at least one user terminal coupled to the at least one network;
at least one application coupled to the at least one server and/or the at least one user terminal, wherein the at least one application is configured for:
collecting data from electronic activity;
conducting at least one electronic data analysis by analyzing the data;
conducting at least one organization data analysis analyzing organization data from the at least one organization; and
creating at least one model of the at least one organization based on the at least one electronic data analysis and/or the at least one organization data analysis.

9. The system of claim 8, wherein the at least one electronic data analysis includes at least one people behavior analysis.

10. The system of claim 8, wherein the at least one model is utilized to create at least one organization activity model.

11. The system of claim 10, wherein the at least one organization activity model is utilized to quantify the at least one organization's activity.

12. The system of claim 1, wherein the at least one model is utilized to create at least one predictive model.

13. The system of claim 12, wherein the at least one predictive model is utilized to forecast performance of the at least one organization.

14. The system of claim 9, wherein the at least one people behavior analysis comprises at least one social network analysis.
